(19) United States
(12) Patent Application Publication
(10) Pub. No.: US 2019/0110417 A1
(43) Pub. Date: Apr. 18, 2019

(54) AQUAPONIC GARDEN DEVICE

(71) Applicant: Aloha Aquaponic Applications, LLC, Hawai, HI (US)

(72) Inventors: Calvin Fen Zeng, Honolulu, HI (US); Jason Chi Sung Chou, WestlakeVillage, CA (US)

(21) Appl. No.: 16/156,981

(22) Filed: Oct. 10, 2018

Related U.S. Application Data
(60) Provisional application No. 62/625,987, filed on Feb. 3, 2018.
(60) Provisional application No. 62/572,276, filed on Oct. 13, 2017.

(51) Int. Cl. A01G 31/06; A01G 7/04; A01K 63/04

(52) U.S. Cl. CPC A01G 31/06; A01G 7/045; A01K 63/003; A01K 63/045; A01K 63/042

(57) ABSTRACT

An aquaponic garden device is described herein. The device is specifically designed for the homeowners living in urban areas where gardening space is limited.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 C.F.R. § 1.57.

### CROSS-REFERENCE TO RELATED APPLICATIONS

The present application claims the benefit of U.S. Provisional Application No. 62/572,276, entitled, A VERTICAL AQUAPONIC GARDEN, and filed on Oct. 13, 2017. The present application also claims the benefit of U.S. Provisional Application No. 62/625,987, entitled AN OUTDOOR/INDOOR RECREATIONAL VERTICAL AQUAPONIC GARDEN, and filed on Feb. 3, 2018. The contents of the aforementioned applications are hereby incorporated by reference in their entireties as if fully set forth herein. The benefit of priority to the foregoing applications is claimed under the appropriate legal basis, including, without limitation, under 35 U.S.C. § 119(e).

### BACKGROUND

The present disclosure relates generally to the field of aquaponics. In particular, but without limitation, the present disclosure relates to recreational and home-style gardening for urban dwellers with limited area for gardening space.

Aquaponics is the combination of aquaculture and hydroponics. The term, Aquaponics, in English is quite young; it has just become a common vocabulary in English since 1981.

In the twenty-first century, because of environmental crises, issues related to climate change, energy crisis, air pollution, water shortage, sea-level rising, and etc. have caused humans to look for the alternative ways to produce food. Looking to nature for inspiration has become popular, and natural aquaponics has been an option for self-sustained food-producing systems. Currently, different types of aquaponic systems in both commercial and residential applications are being explored and practiced in the world, especially in U.S.A., China, and South Asia. It has been shown that aquaponics is a good practice of symbiosis, where plants and animals live harmoniously. Additionally, aquaponics has many benefits for humans as well.

### SUMMARY

There is a need to create a water-saving, space-saving, environmental friendly, recreational and home style aquaponic garden. There is a need for a simple to operate design that solves problems such as liquid filtration blockage, disposal of fish waste, colonization of the nitrifying bacteria, and oxygenating circulating water. Current systems are also expensive in terms of requiring an AC operated aerator and other electrical equipment. The present disclosure is directed toward aquaponics systems designed to address these issues.

For example, the aquaponic system can include a tank, a support column pillar, a distribution device, an irrigation hose, at least one receptacle, and at least one receptacle tray. The distributing pan can include at least one agitating port that is configured to aerate liquid via splashing and the distributing pan can be configured to rotate around the support column pillar. The apex filter can rest on the distributing pan. The irrigation hose of the pump can be configured to travel through the support column pillar and connect to the distribution device and be configured to allow liquid to travel upwards to the distribution device. The receptacle tray can include at least one support frame arranged around a center anchoring ring which can be configured to allow the receptacle tray to rotate around the modular support column pillar. The receptacle can be configured to rest in the receptacle lobes and the receptacle can be configured to be modular and can be detached or removed from the receptacle tray. The receptacle trays can be between the distribution device and the tank, and the liquid can be configured to flow through the distribution device and flow through the receptacles back down to the tank.

The system of any of the preceding paragraphs can include one or more of the following features. The support column pillar can be hollow and can have a base support pillar, at least two spacers, and at least one spacer connector. The receptacle further can have cinder. The cinder can be bacteria treated. A pump can be used to move liquid, and the pump can be powered by solar power or electricity. The system can have at least one grow light. At least three receptacle trays can be attached to the support column pillar via center anchoring rings and arranged vertically and between the distribution device and tank. The receptacle can have at least one receptacle ring unit.

As another example, the aquaponic system can have a tank configured to retain fluid, a hollow support column pillar extending from the tank, a first tray configured to rotate about the support pillar, the first tray can have a first support frame configured to receive a plant, the first support frame can have at least one irrigation hole; and a distribution device configured to distribute fluid through the first support frame and toward the tank, the hollow support column pillar extending from the tank to the distribution device.

The system of any of the preceding paragraphs can include one or more of the following features. The system have a pump configured to direct fluid from the tank and toward the distribution device. The pump can be configured to direct fluid through the hollow support column pillar and toward the distribution device. The pump can be positioned in the tank. The tray can have a central anchor that can be configured to rotate about the support pillar, the first support frame being positioned radially outward from the central anchor. A central longitudinal axis of the first support frame can be parallel to a central longitudinal axis of the central anchor. The support column pillar can be modular. The support column pillar can be configured to removably connect to the tank and the distribution device. The distribution device can have a filter and a distributing pan configured to receive the filter. The distributing pan can have a discharge port configured to direct fluid into the first receptacle unit. A second tray can be configured to rotate about the support pillar, the second tray can have a second support frame configured to receive another plant. The second tray can be positioned between the first tray and the tank such that fluid flowing through the at least one irrigation hole of the first support frame flows into the second support frame of the second tray.

As another example, the aquaponic system can have a tank configured to retain fluid, a hollow support column pillar extending from the tank, a first tray configured to rotate about the support pillar, the first tray can have a plurality of receptacle units, each support frame of the first tray being configured to receive a plant, a second tray configured to rotate about the support pillar, the second tray can have a plurality receptacle units, each support frame of the second tray being configured to receive another plant, wherein the second tray is positioned between the first tray and the tank such that fluid flowing through one of the receptacle units of the first tray flows into one of the receptacle units of the second tray.

The system of any of the preceding paragraphs can include one or more of the following features. A distribution device can be configured to distribute fluid through the plurality of receptacle units of the first tray and toward the tank. The distribution device can have a filter and a distributing pan configured to receive the filter. The distributing pan can have a plurality of discharge ports configured to direct fluid into the plurality of receptacle units of the first tray. A pump can be configured to direct fluid from the tank and toward the distribution device. A pump can be configured to direct fluid through the hollow support column pillar and toward the distribution device. A pump can be positioned in the tank. The first tray can have a central anchor configured to rotate about the support pillar, the plurality of receptacle units of the first tray being positioned radially outward from the central anchor. The central longitudinal axis of each of the receptacle units of the first tray can be parallel to a central longitudinal axis of the central anchor. The support column pillar can be configured to removably connect to the tank. The support column pillar can be modular.

As another example, the aquaponic system can have a tank configured to retain fluid, a hollow support column pillar extending from the tank, a distribution device can have a first filter and a distributing pan configured to receive the first filter, the hollow support column pillar extending from the tank to the distribution device, a tray positioned between the distribution device and the tank, the tray can have a support frame and a second filter positioned in the receptacle unit, the second filter being a different type of filter than the first filter.

The system of any of the preceding paragraphs can include one or more of the following features. The tray can be configured to rotate about the support pillar. The first filter can be a physical filter and the second filter is a bacteria treated filter. The first filter can have a sponge and the second filter can have bacteria treated cinder. A pump can be configured to direct fluid from the tank and toward the distribution device. A pump can be configured to direct fluid through the hollow support column pillar and toward the distribution device. A pump can be positioned in the tank. The support column pillar can be configured to removably connect to the tank and the distribution device. The support column pillar can be modular. A second tray can be configured to rotate about the support pillar, the second tray can have a second support frame configured to receive a plant. The second tray can be positioned between the first tray and the tank such that fluid flowing through the support frame of the tray flows into the second support frame of the second tray.

### BRIEF DESCRIPTION OF THE DRAWINGS

The features disclosed herein are described below with reference to the drawings. The drawings are provided to illustrate embodiments of the inventions described herein and not to limit the scope thereof.

FIG. 1A illustrates an embodiment of an aquaponic garden system.

FIG. 1B illustrates an exploded view of the aquaponic system shown in FIG. 1A.

FIG. 1C schematically illustrates the recirculation of liquid flow in the aquaponic system.

FIG. 1D illustrates another embodiment of an aquaponic system where indoor grow lights and a plug-in watering-cycle programmable timer can be used regulate the intervals of watering time.

FIG. 1E illustrates yet another embodiment of an aquaponic system.

FIG. 2 illustrates an embodiment of a tank.

FIG. 3A illustrates an embodiment of a liquid distribution device.

FIG. 3B illustrates a view of the liquid distribution device.

FIG. 3C illustrates a bottom perspective view of a distributing pan

FIG. 3D illustrates another embodiment of a distributing pan.

FIG. 4A illustrates a perspective view of a support column pillar.

FIG. 4B illustrates another embodiment of a support column pillar.

FIG. 5A illustrates a top perspective view of an embodiment of a receptacle tray.

FIG. 5B illustrates a bottom perspective view of the receptacle tray shown in FIG. 5A.

FIG. 5C illustrates the receptacle tray and the support column pillar.

FIG. 5D illustrates the receptacle tray and a locking mechanism.

FIG. 6A illustrates a bottom perspective view of a receptacle.

FIG. 6B illustrates a top perspective view of the receptacle shown in FIG. 6A.

FIG. 6C illustrates an alternative embodiment of the receptacle.

FIG. 7A illustrates an embodiment of a submersible pump system connected to a power source.

FIG. 7B illustrates an embodiment of a solar panel positioned on the aquaponic system.

FIGS. 8A-8F shows the assembly of an embodiment.

### DETAILED DESCRIPTION

### Overview

In aquaponics, liquid is fed to hydroponic system where the aquatic animal waste products (ammonia or ammonium products that are poisonous to aquatic animals) are broken down biochemically by nitrifying bacteria (e.g. Nitrosomonas and Nitrobacteria communities) into nitrates, which are absorbed by the plants as primary nutrients. The liquid is filtered through filtrating media and recirculated back to the aquaculture system. Vertical aquaponics systems also utilize space more efficiently than other types of aquaponic systems. The top surface of aquaponic system allows photosynthesis to be conducted by plants, and the liquid is a home environment for the aquatic animals. The economic outcome of the aquaponic system also can be profitable as it can produce fresh organic produce and edible fish at low cost.

In the United States, commercially, more aquaponically grown produce and edible fish are provided to local markets, especially in tropical areas. At same time, nationally, more people have turned their front or backyards into organic vegetables gardens. There is also more demand for home-grown vegetables. In areas, such as Hawaii, where land is getting more expensive, more people have moved into condominiums. This has led to smaller gardening areas and little to no gardening activities. As the result, urban homeowners may be interested in space saving gardening setups.

There are many benefits of operating an aquaponic device for a homeowner. The aquaponic device can raise edible aquatic animals, such as like tilapia, catfish, eels, shrimp, snails, and also grow fresh organic produce and/or herbs. Additionally, ornamental plants also flourish in the aquaponic device as well. No insects will attack the vegetable seedlings, because the seedlings are isolated and grow on an “island” that may be soil free and safe guarded by the water. A homeowner would not need to apply chemical or organic fertilizers (saving the homeowner from using harsh chemicals or organic fertilizers with unpleasant odors), because nitrifying bacteria will transform excretions produced by the aquatic animals into rich plant nutrients for the plants. A homeowner would not need to change liquid for the fish, because the bacteria living in the plant cultivating media will keep the liquid clean biochemically, and at same time, filters will physically filter the water. All the homeowner would need to do is to feed the fish and add liquid when the liquid level is low. The system also serves to improve and enhances the viewing value and recreational quality of the homeowner's property.

Currently, there are not many practical aquaponics or hydroponic systems that consumers can choose from. There is a need to create a water-saving, space-saving, environmental friendly, recreational and home style aquaponic garden. Other home-style recreational aquaponic systems have not yet been met with widespread success in commercial aquaponic activities. Home-style aquaponic systems are complex, difficult to install and operate, difficult to clean, static, and bulky. There is a need for a simple to operate design that is constructed and solves problems such as liquid filtration blockage, disposal of fish waste, maintenance of pH levels, micronutrient deletion, colonization of the nitrifying bacteria, and oxygenating circulating water. Current systems are also expensive in terms of requiring an AC operated aerator and other electrical equipment. In addition, prior residential aquaponic systems have been difficult to maintain and are prone to system failure such as new tank syndrome, which leads to death of the fish and vegetables due to poorly designed systems.

The present disclosure describes aquaponics systems in which cascading liquid filtration, plant cultivation, and aquatic animal cultivation in aquaponic systems are integrated vertically. The space-saving home style aquaponic garden innovates the means of how to collect and remove fish waste using an filter positioned at or near an apex of the system (sometimes referred to herein as an “apex filter”). The system can have multilevel rotatable modular growing receptacle trays using bacteria-treated filters, such as cinder. The receptacle trays may hold the plants directly or indirectly through receptacles for liquid filtration and to provide growing beds for vegetables. Use of a bacteria-treated filter, such as cinder, can promote the growth of beneficial nitrifying bacteria to expand their colonies in the system. This bacteria colony expansion can maximize the conversion of ammonia to primary nutrients vegetables use. The aquaponic garden also self generates oxygenated liquid for all the organisms in this symbiotic environment. This aquaponic garden can be operated by AC or DC electricity and operate either outdoors or indoors and does not depend weather conditions when using additions of appropriate lighting. The embodiments described herein improve the aquaponic system problems by using non-static, rotatable growing receptacle trays that allow a grower to best position the plants to maximize photosynthesis, using a modular design that allows for easy installation, using an apex filter device to allow for easy maintenance and cleaning, using a liquid distribution pan and liquid flow path to remove reliance on an aerator device, and using bacteria treated media to aid in nitrification of the system's ammonia/ammonium contents. This home-style aquaponic garden has features that include, but are not limited to:
1. Affordable modular, portable, which allows for hand assembling and dismantling
2. Environment friendly, alternative energy, natural growth media that filters
3. Immediate positive environmental impacts in reducing plastic pollutions
4. Providing recreational and aesthetic views with plants and therapeutic waterfall sounds
5. Economic benefits such as producing 100% organic produce and edible fish
6. Ease of reparability and reduced maintenance requirements results in short system-downtimes
7. Cleaning filtering/growing media is easier in a modular design
8. No seasonal limit, and applicable in any urban area worldwide, indoors or outdoors

Another difference that sets the systems disclosed herein apart from other aquaponic devices is that the liquid can be directed in a predetermined route through the drainage openings at specific positions. Throughout these irrigation routes, liquid can become filtered at different locations and become more oxygenated. Current conventional vertical aquaponic devices have only one filtration structure. The liquid filtration only takes places inside a single column. Specific positioning of the one or more drainage openings (e.g. two openings separated by 120°) on the bottom of a receptacle not only guides and diverts the liquid going to next level below, but also provides the easy and safe irrigation for the plants grown in the containers of next level below. The positioning of the one or more drainage openings can also be varied to other positions around the bottom of the receptacle. From these positions, liquid can be utilized efficiently and in a maximum amount without wasting nutrient rich liquid from splashing fluid out of the system.

In current conventional systems with one large filtering structure or column, liquid can stagnate toward the lower levels. A solid cylinder or mass of growing media can slow liquid flow to the lower level of plants. Liquid in these systems also has less oxygen that at the bottom of the system than at the top of the system, thereby, having less oxygen for nitrifying bacteria at the bottom of the growing media column or growing media mass. In contrast, in the systems described herein, the open elevation between receptacle trays also can provide the growing space for the plants, and the liquid will have enough velocity to enter and exit the subsequent levels creating a smoother flow. The exposure of the liquid between subsequent levels of receptacles also provides additional oxygenation for the liquid as it enters the next subsequent levels of the receptacles. The systems described herein can utilize receptacle trays or other plant holders that can be vertically raised or lowered on the support column to adjust the height and manipulate the liquid flow. Use of a modular hollow support pillar with different sized spacers, spacer-joints, base support pillars, can also allow a user to adjust the liquid flow path by manipulating the sizes of the modular pieces of the modular support column pillar.

The position of the drainage openings also can provide direction for the liquid flow to prevent damage to seedlings. Positioning the drainage openings at specific locations (e.g. two openings separated by 120°) can reduce the possibility of foliage damage.

Another structural advantage to the systems disclosed herein is that each individual receptacle can be managed depending on the physiology of different plant and at the particular stage in their growth cycle. The water flowing from the drain holes on each receptacle guides the water into specified positions. Different type of plants and plants at different growth stages require different optimum watering conditions. For example, basil, chives and mint and others can tolerate more water in growing media (black cinder) than green peppers, cucumbers, and newly transplanted seedling requires less water than fully grown vegetables. In the water distribution device, the water distribution pan can have multiple downspout openings. From each opening the water enters into the receptacles below to irrigate the plants. A micro water control plug can be used to control water flow. The tapered plug has vertical and shallow slots on the round vertical wall. When inserted into the round openings, it does not stop the flow completely and instead can slow down the water flow going to next receptacle below to satisfy the particular plants need.

The invention has multiple different filtration stations at different vertical levels, and each level filtration structure can be physically disconnected from its upper or lower filtration structures. Although the filtration stations at different levels can be structurally disconnected, the water flows can be guided by the drainage openings at the predetermined positions at the bottom of retainers.

### Aquaponic Tower

In general, liquid solution from the tank flows to a filtration unit where solid waste materials are trapped. The liquid with soft or suspended particles is then filtered and the liquid solution flows out to irrigate plants in growing beds with the dissolved nutrients.

Most current home style aquaponic systems are not designed to save space, and are not easy to install on balconies or on small front decks. It also requires tools to assemble the device. It is also difficult and discouraging to dismantle the devices and re-assemble the device when the owners of the aquaponic system have to move from one location to another. Owners of the aquaponic gardens simply cannot assemble or dismantle these aquaponic devices with their bare hands. The systems described herein can be modular so they are easy to assemble, disassemble, and store in smaller spaces.

Other systems use a single column of filtering or growth media in the center tower. This design is clumsy, heavy, and is difficult to change media or change out plants. The systems described herein, allow users to easily change out media or plants due to the modular design.

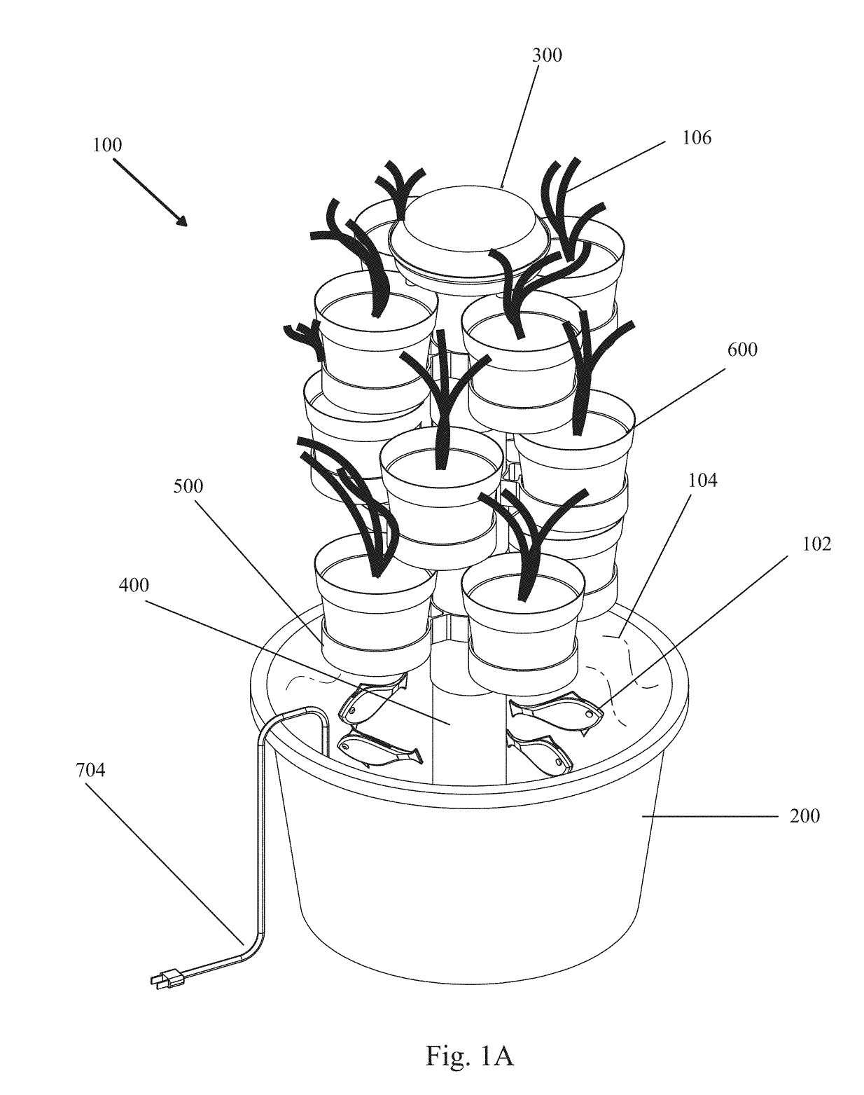

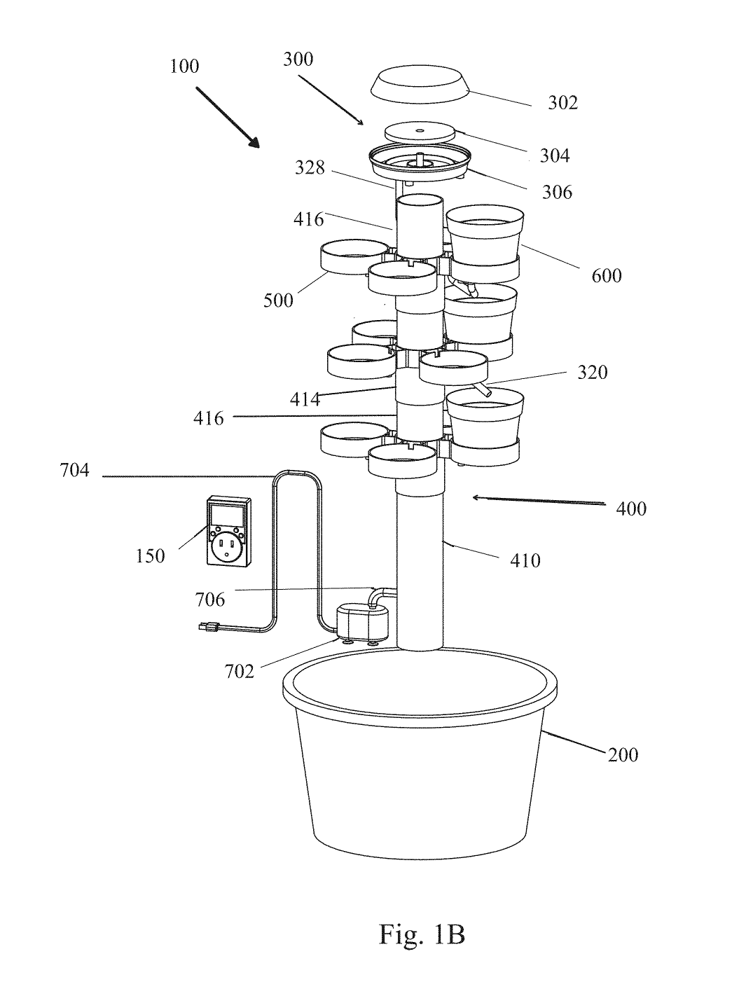

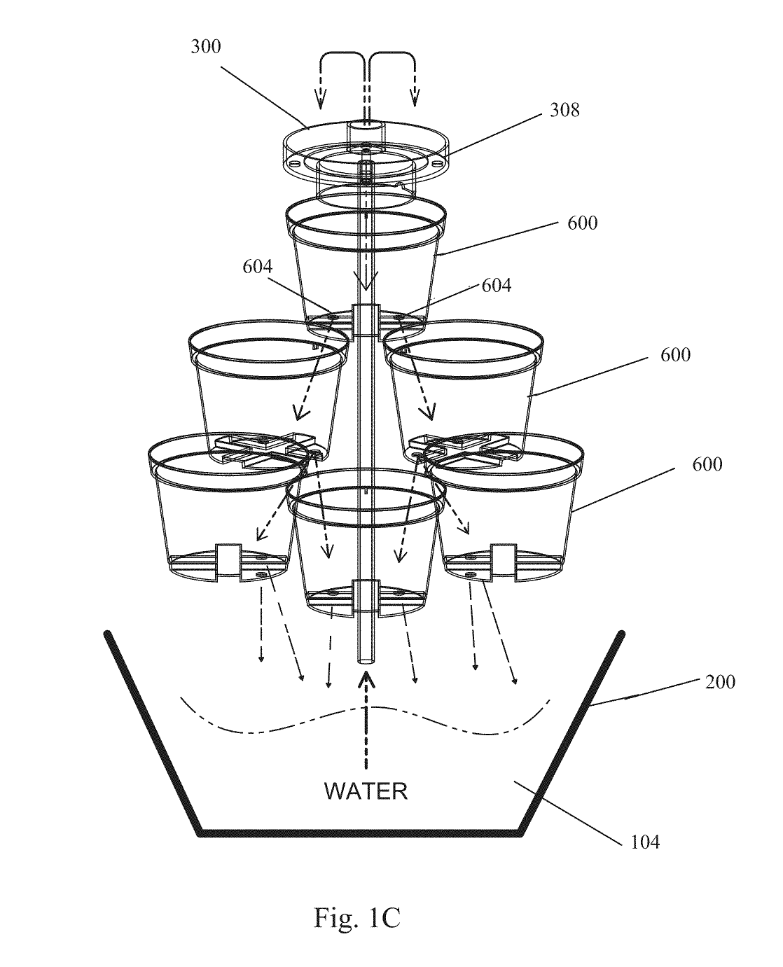

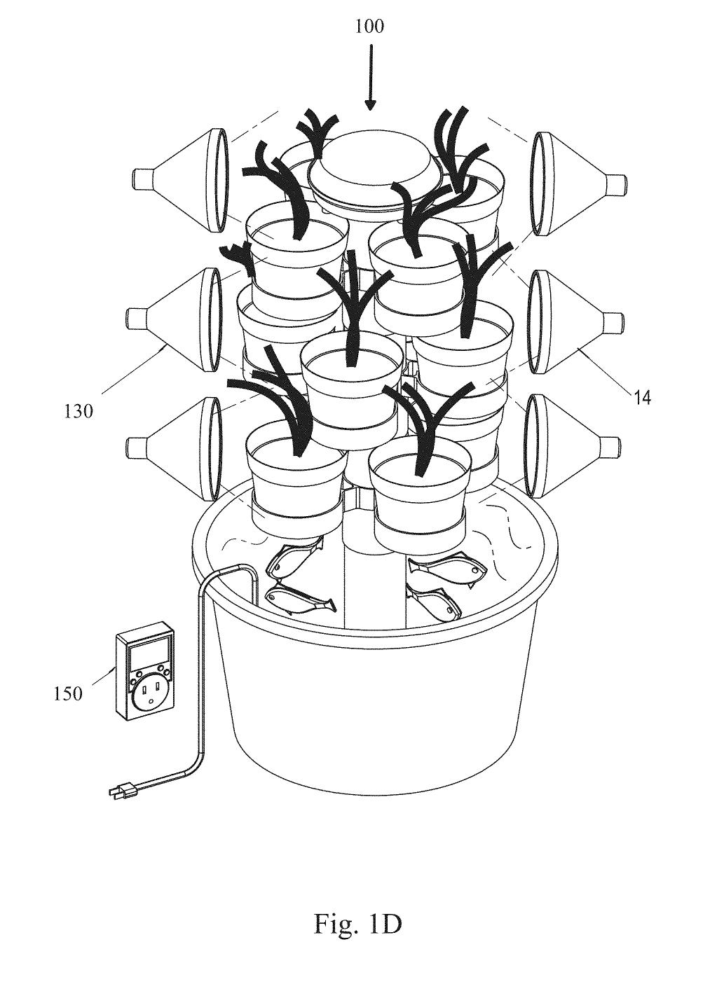

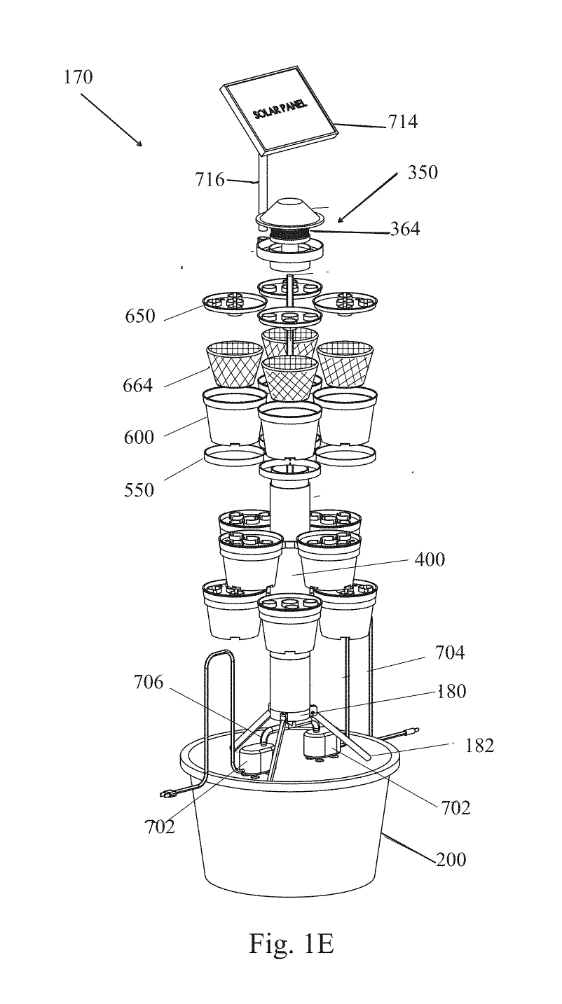

FIG. 1A illustrates an overview of an aquaponic garden system 100 of the system can include a tank 200 with organisms such as fish 102 and/or liquid 104, a liquid distribution device 300 that sits near or at the top of a support column pillar (also called support column or support pillar) 400, multiple leveled tiers of rotatable growing receptacle trays 500 rotatable about the support column pillar 400, receptacles 600 with plants 106, and/or a pump (not shown) with power source cord 704. The receptacle trays 500 may be positioned between the distribution device 300 and the tank 200.

FIG. 1B illustrates an exploded view of the aquaponic system 100. The liquid distribution device 300 can include a lid 302, apex filter 304, and/or a liquid distributing pan 306. One or more receptacle trays 500 can be arranged along the support column pillar 400, which can be integral or modular. As shown, the support column pillar 400 can include a base support pillar 410, spacers 414, and/or spacer connectors 416 (also described herein as spacer joints). The growing receptacle trays 500 can include liquid discharging downspouts 320 to directly liquid flow. The system 100 can also include a pump 702, such as submersible pump, with irrigation hose 706, power cord line 704, and/or an electrical timer 150 with a power source. The aquaponics system can also include a tank 200.

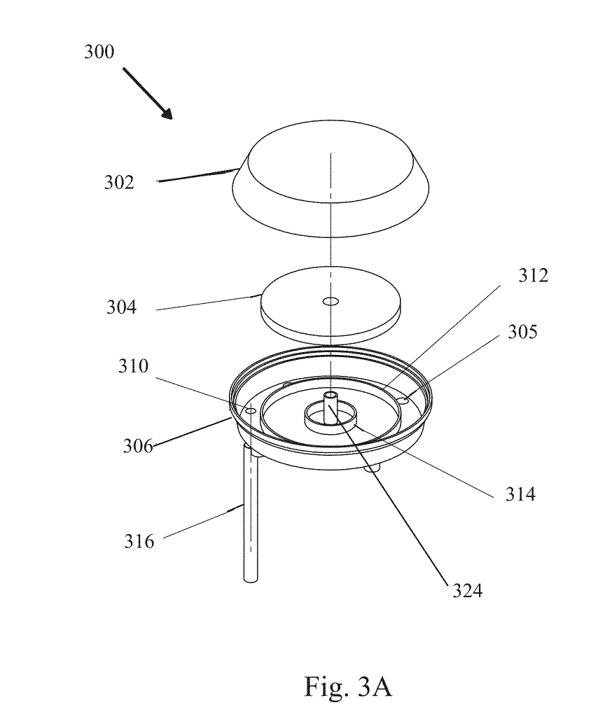

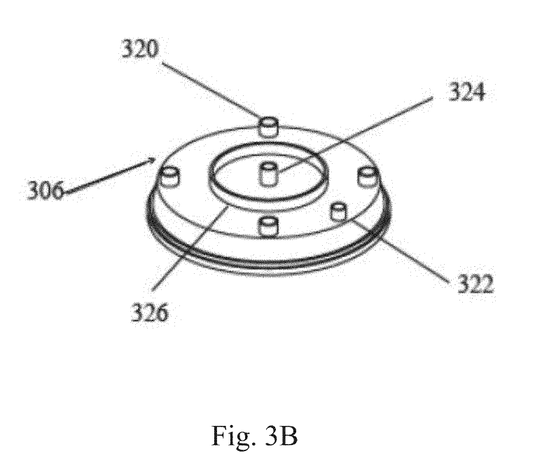

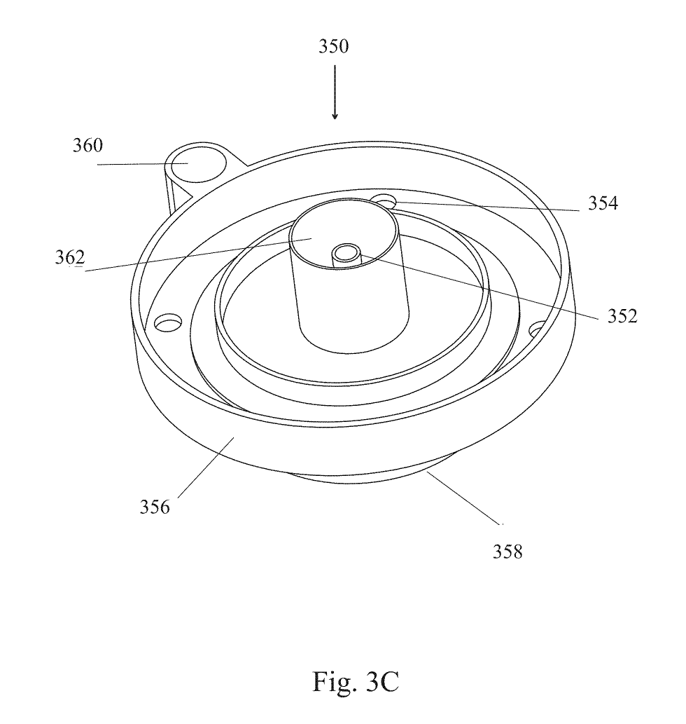

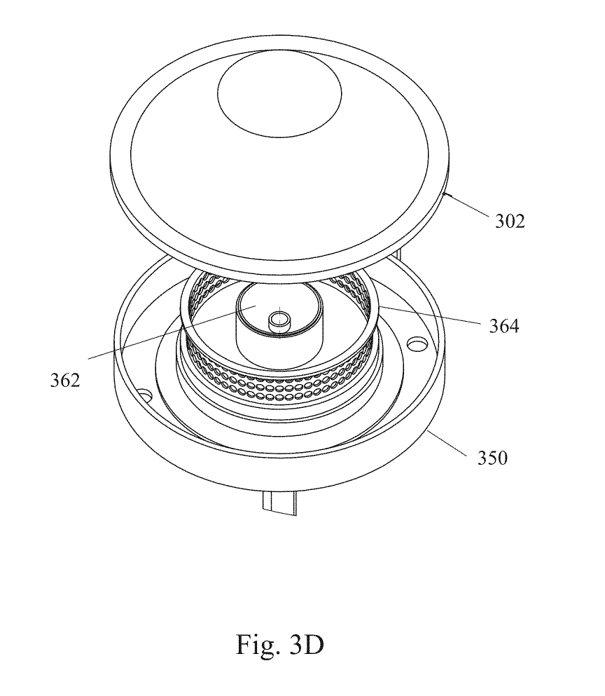

FIG. 1C schematically illustrates the recirculation of liquid flow on a side of the vertical aquaponic system with one or more receptacles 600. Each receptacle 600 can be situated in a receptacle tray that can include one or more integral or separate receptacles for holding a plant. Starting from the tank 200, liquid 104 is pumped through the support column pillar 400, for example through irrigation hose 706, to the liquid distributing pan 306 via a pump. Liquid 104 travels to the first tier of receptacle(s) 600, for example via one or more liquid discharge ports 308 in the liquid distributing pan 306. Liquid 104 then cascades down to the second tier of receptacle(s) 600 and then to the subsequent, third tier of receptacle(s) 600, for example via one or more drain holes 604 in the receptacle(s) 600. Although not shown, four tiers, five tiers, six tiers, seven tiers of receptacles or more can be used. For example, the number of tiers used may be dictated by the strength of the submersible pump used in the system. After the liquid 104 flows through the one or more tiers of receptacles 600, the liquid 104 then finally travels back to the tank 200. In some embodiments, the liquid distributing pan has a liquid agitating port and liquid agitating hose. The liquid 104 that travels through the liquid agitating port falls to the tank 200 and creates splashes. These splashes aerate the liquid 104 in the tank 200 and oxygenizes the liquid 104. Further detail regarding the liquid agitating port and liquid agitating hose are described in FIG. 3A.

As shown in FIG. 1D, the aquaponic system 100 can optionally include indoor grow lights 130 and/or a plug-in watering-cycle programmable timer 150 can be used regulate the intervals of watering time. Grow lights 130 can be high pressure sodium grow light systems, metal halide grow light systems, fluorescent grow lights, HID lamps, LED light systems, fluorescents, and/or etc. Grow lights can be used in systems that are used indoors.

FIG. 1E illustrates another embodiment of the vertical aquaponic system 170, which can include any of the features of the system 100. In system 170, the solar panel 714 is attached to the system via a solar panel post 716.

As shown in FIG. 1E, the system 170 can include a liquid distribution pan 350 that uses an apex filter ring 364, which is described in further detail below with respect to FIG. 3D. The system 170 can include one or more receptacle covers 650 to encase a filter, such as cinder mesh bag 664, in a receptacle 600, which may be integral with or separate from a receptacle tray. For example, the receptacles 600 may rest on or be received by the receptacle rings 550 that are arranged around the support column pillar 400.

The cinder mesh bag 664 can allow for easy removal of the filtering media. The support column pillar can have an integral or modular base 180 with one or more legs 182 which is set in the tank 200. For example, the base 180 can have an anchoring ring to attach it to the support column pillar 400. The base 180 can be set in the tank 200 or it can be suspended over the liquid level in the tank 200. The system 170 can include one or more submersible pump systems 702, for example a dual system, for use with a corresponding number of irrigation hoses 706 and cord lines 706.

### Tank

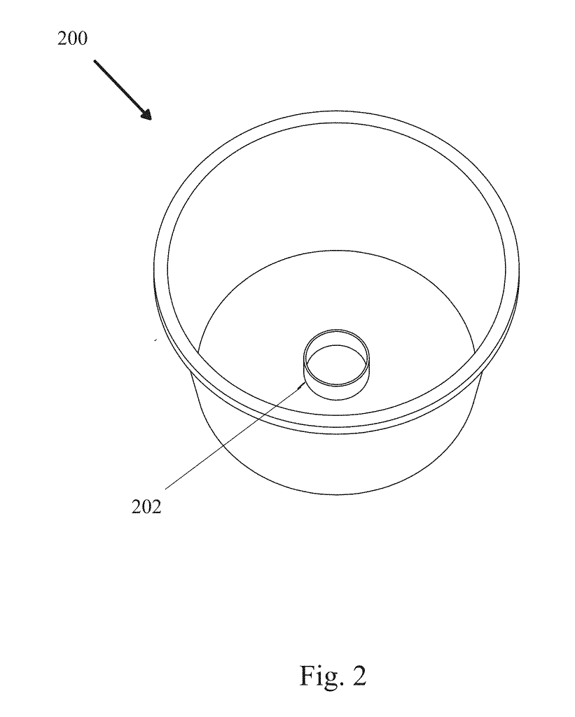

FIG. 2 illustrates an embodiment of the tank 200. The tank 200 can be any shape, for example cylindrical, frusto-conical, rectangular, or box-like in shape. The tank 200 can be clear, semi-transparent, or opaque. In some embodiments, the tank 200 can have wheels or sliders placed on the bottom of the tank to aid in ease of movement.

The tank 200 can optionally include a pillar seat 202 that the support column pillar of the vertical aquaponic systems attaches to. For example, the pillar seat 202 can be a female or male connecting piece. The user can slide or otherwise attach the support column pillar 400, as shown in FIG. 1B, over or on the pillar seat 202 to anchor the support column pillar 400 to the tank 200. In some embodiments, there is no pillar seat 202 and the support column and tank 200 are one piece. In some embodiments, the support column can be one piece.

In some embodiments, a pH measuring device can be used and placed in the tank 200, on the support column pillar 400, or anywhere in contact with the water. A pH measuring device can indicate to a user how much liquid should be added to the system. Improper pH levels can kill certain organisms or cause algae-blooms which compete with plants for the nutrients in the water. In some embodiments, a user can add chemically, nutrient, and/or fertilizer treated liquid in the tank.

### Liquid Distribution Device

FIGS. 3A and 3B illustrates an exploded view of the liquid distribution device 300. The liquid distribution device 300 can include a lid 302, an apex filter 304, and/or a liquid distributing pan 306. The liquid distributing pan 306 can receive or hold the apex filter 304 on filter rest 314. The apex filter 304 may be ring-shaped to receive the liquid discharge spout 320. The liquid distribution device 300 can be easily assembled due to its modular design and it can easily be placed and taken off the top of the top of the vertical aquaponic system 100. This modular design can allow for easy cleaning or replacement of parts of the liquid distribution device 300.

The lid 302 redirects the liquid from the tank 200 into the liquid distributing pan 306. The liquid can flow from the one or more liquid discharge ports 305 as shown in FIG. 1C. Optionally, there may be liquid discharge downspouts 320 extending from a corresponding port 308 to directly liquid flow to the receptacle trays 500. The liquid distributing plan may also include one or more agitating ports 310, agitating downspouts 322, and/or liquid agitating downspout hoses 328. Liquid agitating hoses 316 can be connected to the liquid agitating downspouts 322. Unlike discharge ports 305 which direct liquid into the receptacles, liquid agitating ports 310, agitating downspouts 322, and downspout hoses 316 can be used to direct liquid to leave the distribution pan 306 and fall into the tank to create splashes to aerate the liquid.

The distributing pan 306 may include an interface for attaching to the support column pillar 400. For example, as shown in FIG. 3B, the distributing pan 306 may include an alignment ring 326 can provide a snug fit with the support column pillar 400 below.

The apex filter 304 can include a coarse material that can filter out larger pieces of organism effluence from the liquid pumped from the tank 200. In some embodiments, the apex filter 304 is circular with a central aperture. One of the tasks that owners of aquarium or aquaponic systems dislike doing is cleaning the system (e.g. cleaning and maintaining the liquid filtration system and/or plant growing beds). For many aquaponic system owners, the current conventional liquid filtration and fish waste collecting systems are inefficient, clumsy, and dirty. These systems are unpleasant to clean and dispose the smelly fish waste, especially in small areas. By rinsing out and disposing of the filtered effluence in the apex filter 304, a user needs minimal cleaning effort. The apex filter 304 can include a sponge or any other coarse filtering material. The apex filter can also be used to clean out the rest of the liquid distribution device 300. A user can simply rinse or throw away the apex filter 304.

As to the assembly of the liquid distribution device 300, the final position of the liquid distributing pan 306 is adjustable and can be at or near the top of the support column pillar 400. The liquid distribution device 300 can be rotated until its one or more liquid discharge ports 308 are directly over the corresponding receptacles 600. The apex filter 304, which can be a round or any shape that facilities easy assembly, can then be placed on the filter rest 314 and/or waste block ring 312. The lid 302 can then be placed on top.

Removing large pieces of fish waste/effluence at the highest location of the aquaponic system is an improvement over current filtering systems in the home-style aquaponic device products. The system may have periods where the pump in inactive. For example, the pump may stop pumping after the sun settles down or due to the timer or due to the lack of solar power for the system, the photosynthesis stops as well. The waste that is intercepted by the apex filter 304 at the top of the filtering system is deposited in the fibrous apex filter 304. The apex filter 304 can be easily removed from the liquid distribution device 300. The apex filter 304 can be reusable after washing. This modular design makes the cleaning job much easier and much effective. Unlike current systems, the pump no longer has to be removed to get the waste out. The collected waste can be simply removed off the top of system instead of digging around the liquid to get the collected waste. After the liquid is filtered through apex filter 304, it can flow through the one or more liquid discharge ports 308 and/or a liquid agitating ports 310. The total liquid flow in the liquid distribution device 300 can then be then divided into separate flows through the liquid discharge ports 308 and/or liquid agitating ports 310. The liquid that travels through liquid discharge ports 308 and fall on the receptacles 600 of the first tray 500 to irrigate plants. Some of the liquid flow may directly fall into the tank via the agitation ports to produce oxygen as further described herein. Immediately, the liquid starts to irrigate the vegetable seedlings growing in the receptacles 600. Different watering intervals can be set by the programmable timers to optimize the growth of the plants according their ages and their physiological characters, and to save electricity.

FIG. 3C shows another embodiment of a liquid distribution pan 350. In addition to any of the features of distributing pan 306, the distributing pan 350 may include a hose connector 352, a drain hole 354, a pan rim 356, a round base 358, a solar panel seat 360, and/or an apex reservoir 362. This embodiment allows a solar panel device to be affixed to the system. The apex reservoir 362, allows alternative apex filter designs to be used. The pan rim 356 and round base 358 allow for a snug connection with a lid (not shown).

FIG. 3D shows another embodiment of a distributing system 300 where an apex filter ring 364 is used instead of an apex filter in the alternative embodiment of a liquid distribution pan 350. This apex filter ring 364 also provides another easy cleaning solution alternative to the system. The apex filter ring 364 does not use a coarse material to filter effluence from the liquid. Instead, it can use holes on the side of the apex filter ring 364 as a filter mechanism for effluence. The apex filter ring 364 design may allow greater durability than the apex filter design.

### Support Pillar

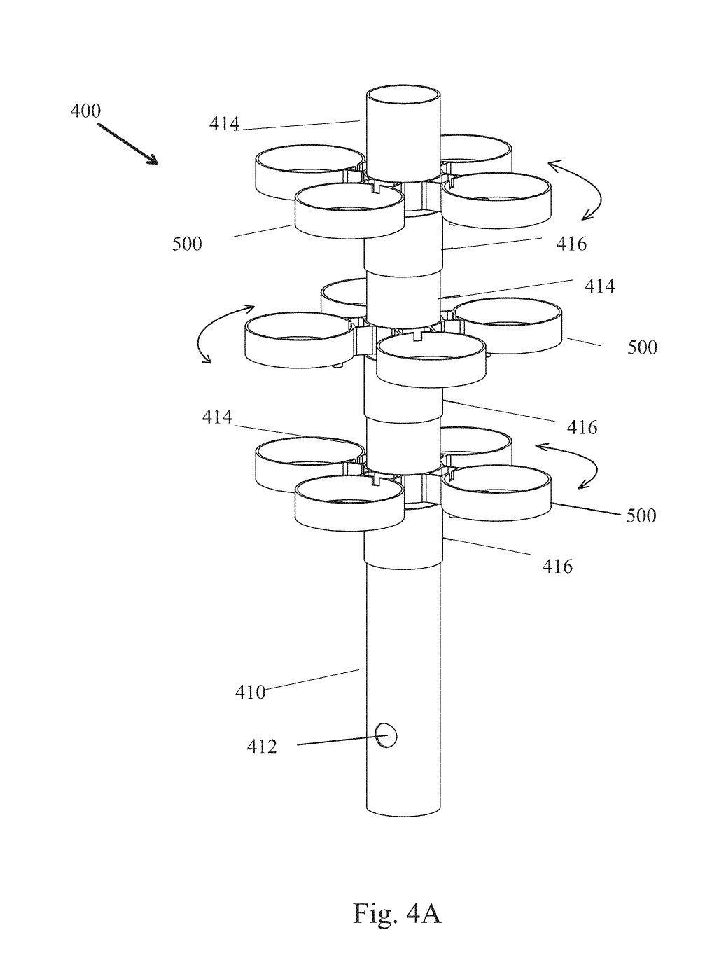

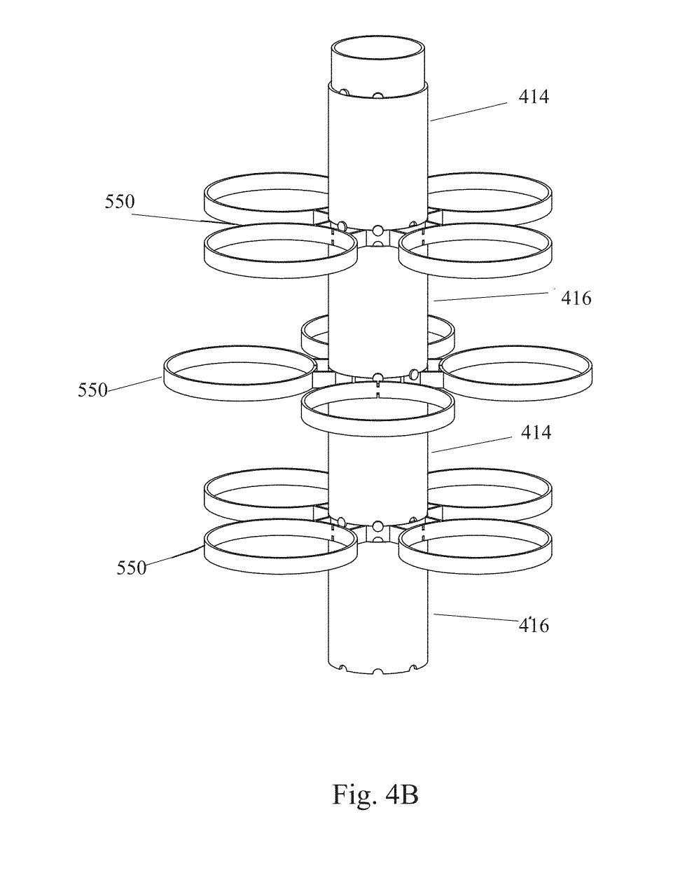

FIG. 4A illustrates a perspective view of the support column pillar 400. The support column pillar 400 can be one-piece or can have a modular design. The support column pillar 400 can be hollow or solid. For example, FIG. 4A shows an embodiment that has the modular connecting features of the center anchoring ring of the receptacle trays 500, spacers 414, spacer connectors 416, and/or a base support pillar 410. Each receptacle tray 500 can be rotated freely around the spacer and can slide up and down to adjust the height in order to optimize the irrigation of the vertical aquaponic system and photosynthesis activities of the plants. The support column pillar 400 can have a base pillar 410. The support column pillar 400 may be hollow for liquid flow, for example, an irrigation hose may extend through a hole 412. The irrigation hose can travel up the support pillar and can be connected to the liquid distribution device 300. The spacers 414, spacer connectors 416, and the base support pillar 410 can be varied in size and dimension to provide a customizable height for the vertical aquaponic system 100.

One end of the base support pillar 410 can be inserted and secured to the tank, for example to the pillar seat as shown in FIG. 2. In a modular configuration, the other end of the base support pillar 410 can be connected directly or indirectly to a spacer 414, for example using a spacer connector 416. The receptacle tray 500 can then be connected to the support column pillar 400, for example through the center anchoring ring of the receptacle tray 500. The spacer connectors 416 may provide stopping positions for the receptacle trays 500. This process can be repeated until the required levels of the receptacle trays 500 are assembled. The liquid distribution device 300 may be secured near or at the top of the support column pillar 400. The receptacle trays 500 and/or the liquid distribution device 300 can be axially rotated, so that the levels of the receptacles trays 500 are arranged in optimal position to facilitate liquid flow directly from the liquid distribution device 300 to the first tray 500 and from the first tray 500 to subsequent trays.

In some embodiments, the support column pillar 400 may be solid with no central lumen and the irrigation hose can travel alongside to the column to the liquid distribution device 300. In some embodiments, the support column can be one piece instead of a modular support column design. In some embodiments, the spacers 414, base support pillar 410, and/or spacer connectors 416 can all be varied in dimensions to allow a user to customized the heights between tiers of the levels in the system.

### Aeration

Any aquaponic system, both commercial and residential, oxygen is needed maintain the health growing of all aquatic animals, aerobic nitrifying bacteria and vegetables. Without proper aeration, organisms within the system can perish. In most home-style aquaponic systems, a separate aerator is often applied to generate oxygen in the liquid for the symbiotic environment. Separate aerator adds costs to the system in the form of the price of the aerator and the price for the power bill. The liquid agitating ports 310, downspouts 322, and/or hose 316 directs liquid to splash in to the tank 200. The splash effects generate oxygenation of the liquid location in the tank 200, which oxygenates the system without the need of a separate aeration unit. However, separate aeration units can be used as well. Liquid traveling between tier levels also can be exposed to oxygen and allow aeration of the water. Additionally, the liquid splashes from the discharge of liquid from the last bottom tier of receptacles also causes aeration.

Another difference that sets the presently disclosed systems apart from other aquaponic devices is that the liquid flows route directs liquid in a predetermined route through the drainage openings at specific positions. Throughout these irrigation routes, liquid can become filtered at different locations, for example at the apex filter 304 and within the receptacles 600, and become more oxygenated. Current conventional vertical aquaponic devices have only one single column filtration structure. The liquid filtration only takes places inside the single filtration station. Here, specific positioning of one or more drainage openings (e.g. two openings separated by 120°) at the bottom of each receptacle 600, not only guides and diverts the liquid going to next level below, but also provides the easy and safe irrigation for the plants grown in the containers of next level below. From these positions, liquid can be utilized efficiently and in a maximum amount without wasting nutrient rich liquid from splashing fluid out of the system.

The open elevation between two retainer trays also can provide the vertical growing space for the plants, and the liquid will have enough velocity enter and exit the subsequent levels creating a smoother flow. In current conventional systems with one large filtering structure or column, liquid can stagnate toward the lower levels. Here, the longer exposure of the liquid traveling between subsequent levels of receptacles due to longer distance of traveling between tier levels also provides additional oxygenation for the water.

Further, in current vertical aquaponic devices systems, a solid cylinder or mass of growing media slows liquid flow to the lower level of plants. Liquid in these systems also has less oxygen that at the bottom of the system than at the top of the system, thereby, having less oxygen for nitrifying bacteria at the bottom of the growing media column or growing media mass. The systems described herein can utilize receptacle trays 500 and/or receptacles 600 that can also be vertically raised or lowered on the support column to adjust the height and manipulate the liquid flow. Use of different sized spacers, spacer-joints, and/or base support pillars, can also allow a user to adjust the liquid flow path by manipulating the sizes of the modular pieces of the modular support column pillar.

The position of the drainage openings also can provide direction for the liquid flow to prevent damage to seedlings. In other conventional systems, liquid flow can vertically hit the foliage of the young seedlings and damage plants via foliage damage. Positioning the drainage openings at locations can reduce the possibility of foliage damage (e.g. two openings separated by 120°).

To generate maximum waterfall splashing and system liquid oxygenation, the length of base support pillar 410 can be longer than the depth of the tank 200, so a greater vertical distance between the bottom receptacles tray 500 and the liquid surface of the tank 200 can be created. This vertical elevation makes it possible to create a mini-waterfall in the system 100, along with the liquid discharged from liquid agitating port 310 directly to the liquid surface in the tank 200. The splashes can also create a very soothing and relaxing sound. The water, originating from the tank 200 is pumped up to the apex of the embodiment and then facilitated by gravity, to travel down through receptacles 600 and contacts the liquid surface to produce bubbles and provide aeration. The system continuously produces splashes and liquid bubbles that agitate the liquid in the tank 200, and this oxygenated liquid can then be pumped back to the apex of the system, creating a constant flow of oxygenated liquid through the media. Oxygenated liquid can also keep the aerobic nitrifying bacteria colony healthy, and in return, the bacteria decompose the waste and to convert the poisonous ammonia compounds to nitrite and nitrate compounds. Thus, this closed recirculating system completes its circle of the operation. Aquatic animals, beneficial bacteria, and vegetables live and thrive in this symbiotic community.

FIG. 4B shows an alternate embodiment of the modular support column pillar where receptacle rings 550 are used instead. The receptacle rings 550 may be open with a top opening and bottom opening with a central lumen extending therebetween. Receptacle rings 550 may not have a bottom surface with built-in ports. Receptacles 600 can be simply carried by the rings 550 and can rely on water drainage ports in the receptacles 600 for directed water flow.

### Receptacle Trays

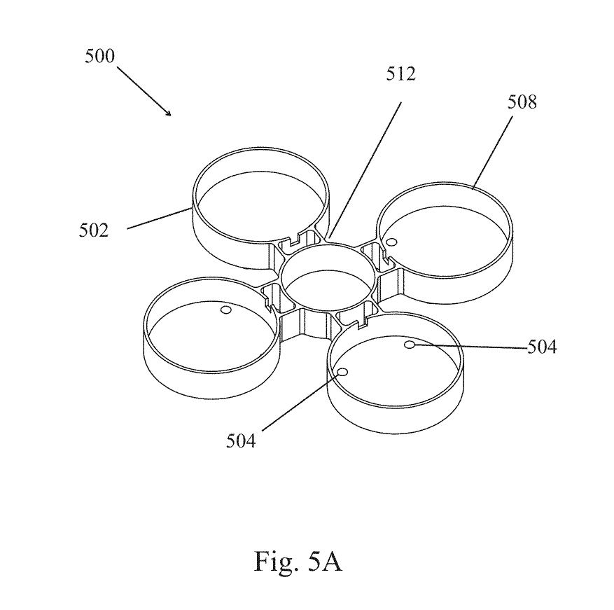

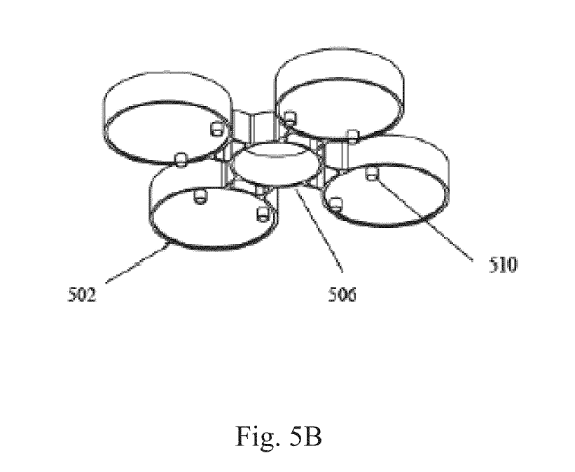

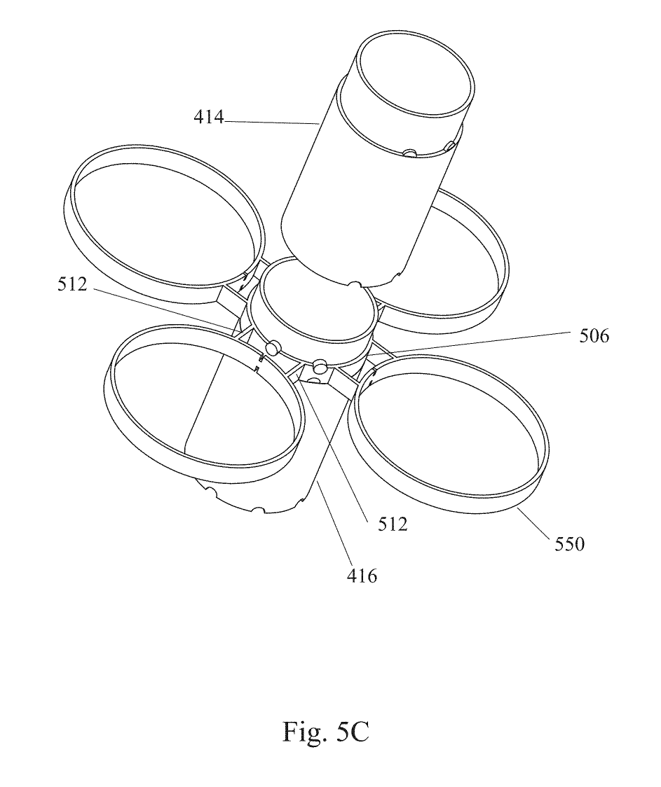

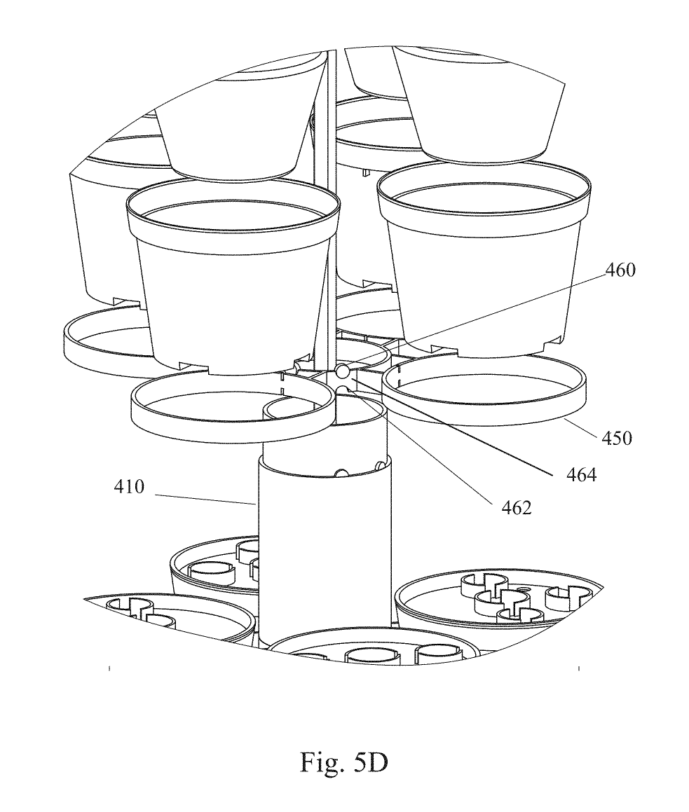

FIGS. 5A and 5B show a top view and a bottom view of an embodiment of the receptacle tray 500. Each tray 500 can include one or more support frames 502, for example three, four, five, six, seven or more circumferentially arranged support frames 502. Each support frame 502 can be a receptacle 600 that receives a plant or support a separate receptacle 600 that receives a plant. Each support frame 502 may have one or more irrigation holes 504. For example, there can be one, two, three, or more irrigation holes 504 on the support frames 502. The irrigation holes 504 may be circumferentially displaced, for example in a 10 o'clock and 2 o'clock positions. In a modular configuration, the irrigation holes 504 can be aligned with the drain holes of receptacles 600. On the bottom of the support frames 502, irrigation downspouts 510 may extend from the irrigation holes 504 to directly liquid flow. The support frames 502 can be round, square, triangular, hexagonal, or other geometric shape designs. The support frames 502 can have a lip 508 to secure the receptacles 600. The receptacles 600 can be arranged around the center anchor 506, which may be ring-shaped. The support frames 502 can be attached to the center anchor 506 with a bridging construct 512 to radially extend the support frames 502 from the support column 400. The bridging construct 512 can have open space in order to minimize the amount of material needed to make the receptacle trays 500 or to increase the durability of the receptacle trays 500. In some embodiments, the receptacles 600 may have multiple perforations to assist in draining. In some embodiments, the support frame 502 may have a single down spout structure which funnels liquid drainage from the receptacle. The center anchor 506 allows the receptacle trays 500 to slide up and down the support column pillar 400 and rotate around the support column pillar 400 as shown in FIG. 4.

FIG. 5C shows another embodiment of a receptacle tray 550, which may include any of the features of tray 500. Instead of receptacle trays 500 with support frames 502, receptacle rings 550 are used instead. The rings 550 may have an open top end and an open bottom end. FIG. 5B also illustrates how center anchoring rings 506 connects with spacer connectors 416 and spacers 414. For example, receptacle rings 550 may not have a bottom surface with built-in ports. Receptacles 600 can be simply carried by the rings 550 and can rely on water drainage ports in the receptacles 600 for directed water flow.

FIG. 5D shows an embodiment where a lock mechanism 460 is used to anchor the center anchor 506 to the support pillar 400. A suspender male key 462 and a suspender female key 464 can be used.

### Receptacles

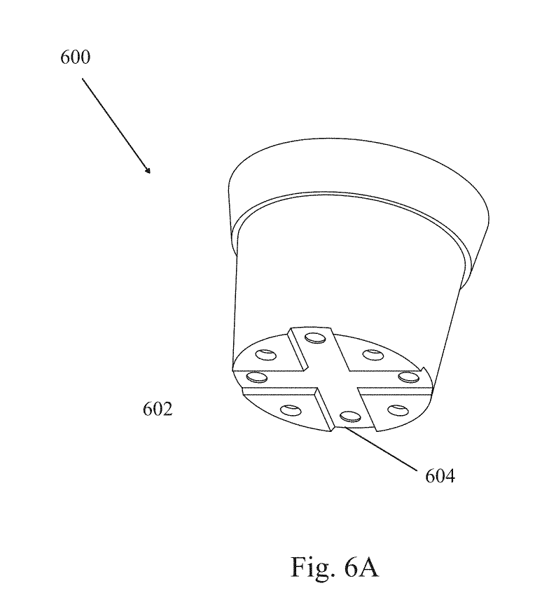

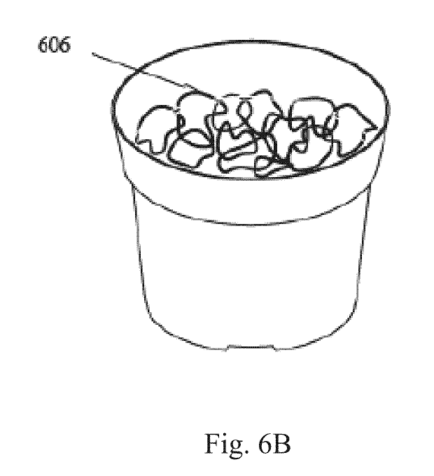

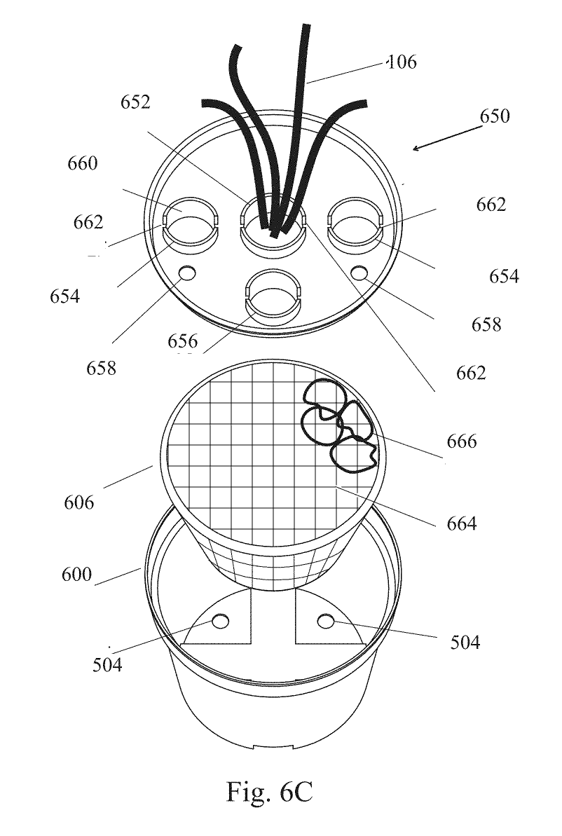

FIGS. 6A and 6B show two views of a receptacle 600, which may be integrated with tray 500 or separate from tray 500. The receptacles 600 can be filled with growing media 606. In some embodiments, growing media 606 can include sand, gravel, clay balls, crushed stones, expanded shale, pebbles, soil, cinder, etc. When the growing media 606 is placed in the receptacles, the media 606 functions as a filter. The receptacles may have one or more drain holes 602 or an otherwise perforated bottom. The receptacles 600 may be have bottom crossed-slots 604 recessed from a bottom surface of the receptacle 600 to aid in draining of the liquid and prevent liquid clotting. The receptacles 600 can be round, square, triangular, hexagonal, or other geometric shape designs. In a modular configuration, the receptacles 600 can be easily removed and reinstalled to the receptacles units 502 of the receptacle trays 500, one can easily replace or remove the receptacles 600. This can be done to replace media, harvest the plant, remove broken receptacles, or better position plants on the vertical aquaponic system.

In aquaponics, plants are cultivated by utilizing the nutrients which are broken down from animal excretions. Certain kinds of plant cultivating media have to be applied as root anchoring bases and plant growing beds. Furthermore, this plant cultivating media not only provides the best anchoring base for plant roots, but also provides the home for those beneficial nitrifying bacteria. Current plant cultivating media does not have high liquid filtering rate as the individual units of these filtering media does not filter liquid efficiently.

Possible filters can be clay balls, pebbles, crushed stones, expanded shale, cinder, etc. Cinder can be a porous lava rocks that are suited for liquid filtering, but can also hold liquid and absorb the liquid in its cavities. Cinder can be porous, floats when in a dry state, holds liquid after drenching, and is ideal for plant capillary roots to attach. Cinder surface area can be relatively much bigger than other type media materials with same dimensions. Cinder can work very well as liquid filtering media when piled in columns. Cinder occurs naturally and is easy to collect. Cinders and their cavities can make the perfect environment for the beneficial nitrifying bacteria. The nitrifying bacteria can thrive in cavities, and adhere with the cinders even after heavy washes.

As such, cinder can be used as cultivating media, which is common occurring and cheap, can be used in the receptacles 600. Unlike other systems which place growing media in the center column, here the growing media is placed in the receptacles 600. This leads to easy removal of the growing media from the system, as the media or cinder can easily be replaced if too dirty, cleaned, or re-inoculated with bacteria. In other systems, it is difficult to replace growing media. In some embodiments, black cinder is used. In some embodiments, red cinder can be used.

The growing media, such as cinder growing media, can be inoculated with beneficial nitrifying bacteria (e.g. Nitrosamines and Nitrobacteria) that convert ammonia into nitrite, and then nitrite into nitrate. Cinder, at the same time, can provide anchoring points for plant roots. The physical characteristics of porous cinder make crushed cinder one of the best natural cultivating medias and the best natural liquid filtering medias. For instance, in the State of Hawaii, volcanic cinder rocks filter rainwater for human consumption. Cinder can also hold moisture and air. Liquid and air can pass through the porous cinder. When liquid passes through the packed cinder columns in the receptacles, liquid is not only between filter between the compacted cinder grains, but also through the pores of individual cinder grains. Compared with crushed rocks or clay balls, cinder has very coarse concave/convex surfaces, and because of these physical features, cinder can be a better habitat for the beneficial nitrifying bacteria. Thus, the aerobic nitrifying bacteria can develop and expand colonies quickly inside cinder. Additionally, plants also take advantage of porous cinders by quickly developing their anchoring roots and nutrient absorbing capillary roots. As the liquid passes through cinder, nutrients can be metabolized by the plant roots and the nitrifying beneficial bacteria. Once plant seedlings are transplanted in the receptacles, the root system starts to develop. Most cinder grains can then be eventually either bonded or penetrated by strong roots of these vegetables. Well-developed root networks increase area for plant anchoring as well as for absorbing nutrients in the cultivating media. As the result of healthy roots, plants thrive. As shown in FIG. 1C, the liquid travels down to the receptacles 600 below. The liquid from upper level can be directed to fall into the specific spots at next bottom level. The filtering process repeats itself until the liquid hits the liquid surface in the tank 200. Since the system can be a closed recirculating system, the same nutrient carrying liquid travels through all of the modular receptacles 600, but at different locations.

FIG. 6C shows another embodiment of a receptacle 600 using a filter-receptacle cover 650. The cover 650 may include one or more cultivating holes 662, medium size cultivating holes 654, and/or small size cultivating holes 656 for plants 106. The cover 650 may also include surface drainage holes 686. Seedling resting rims 660 with drain slots 662 that surround the cultivating holes 662, 654, 656. A filter, such as a mesh bag 664 with cinder 666 or other growing media, may be positioned within the receptacle 600.

### Submersible Pump System and Power Sources

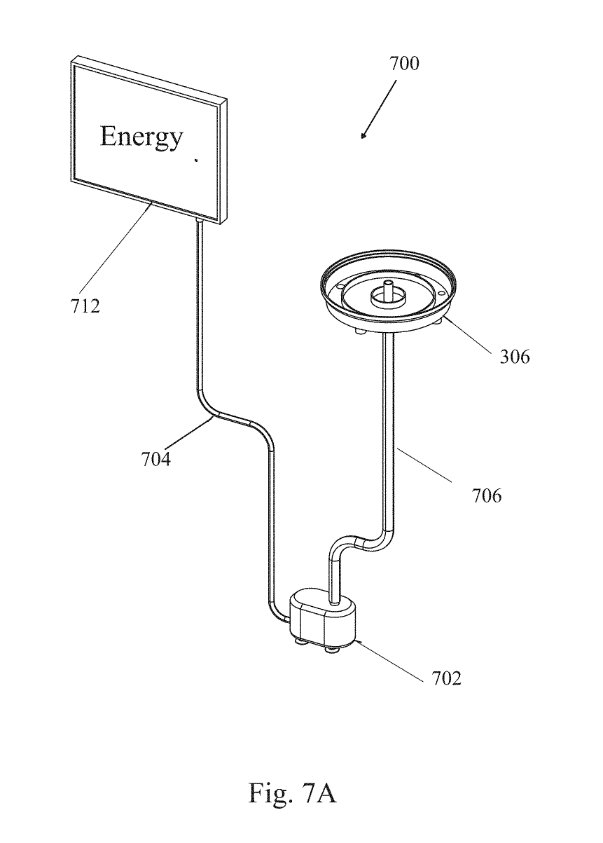

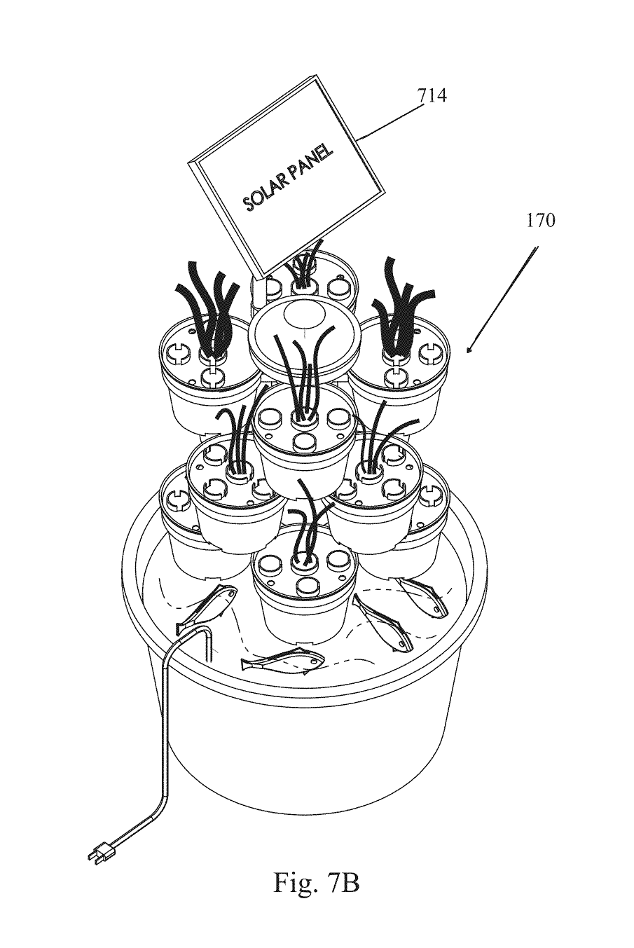

FIG. 7A shows an embodiment of a pump system 700. The system 700 can include a pump 702, irrigation hose 706, a power cord line 704, and/or power source 712. The pump 702 may be a submersible pump. The irrigation hose 706 can travel through the support column pillar 400, and allows the liquid from the tank 200 to travel up to the liquid distribution pan 306. The pump 702 can be connected to a power source 712. The pump 702 can either powered by household AC electricity as shown in FIG. 1B, solar electricity, or any other type of alternate energy source, such as wind power, because finding outlets on balconies or backyards can be challenging. A timer can also be used to stop the pump. In solar powered systems, the pump can stop when the day ends. FIG. 7B shows an embodiment where a solar panel 714 is used and positioned in the center of a vertical aquaponic system 100 embodiment.

### Method of Assembly

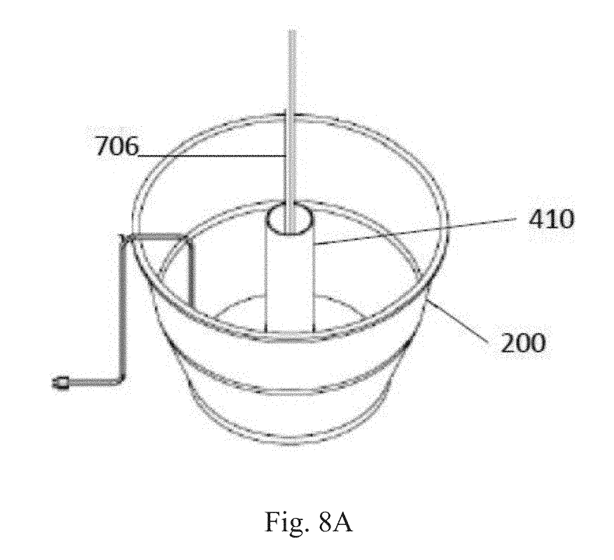

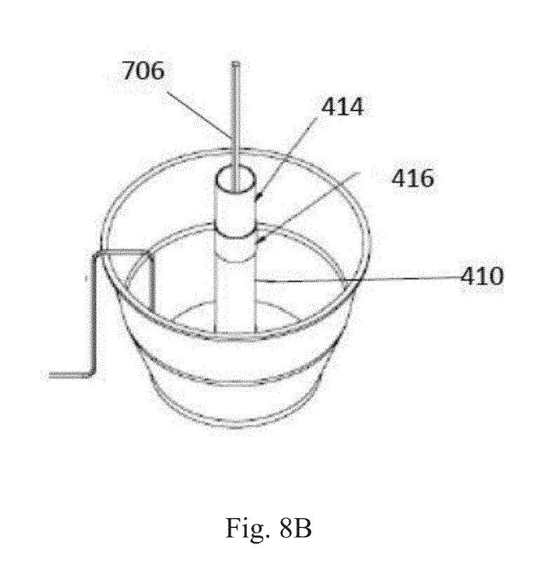

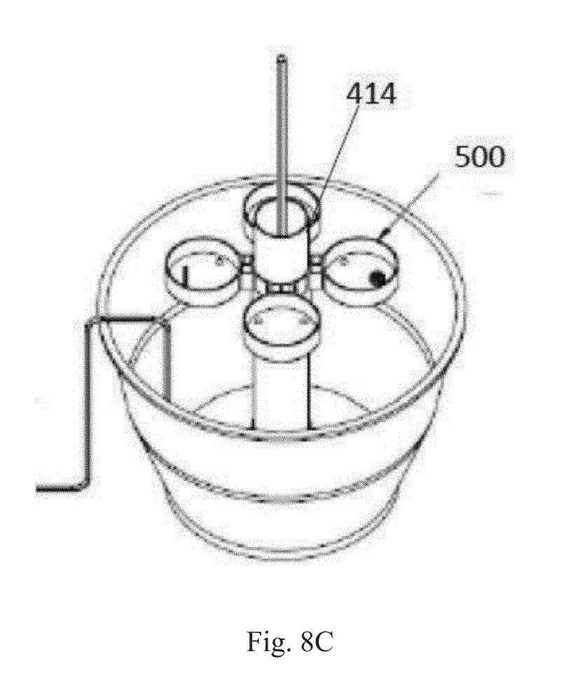

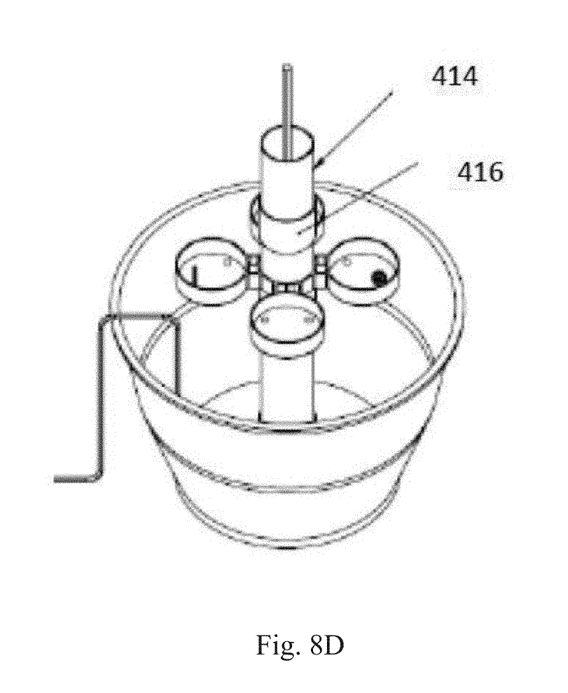

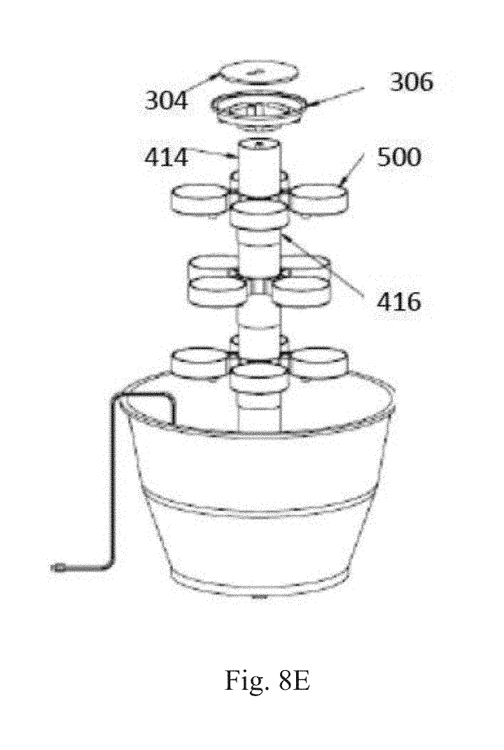

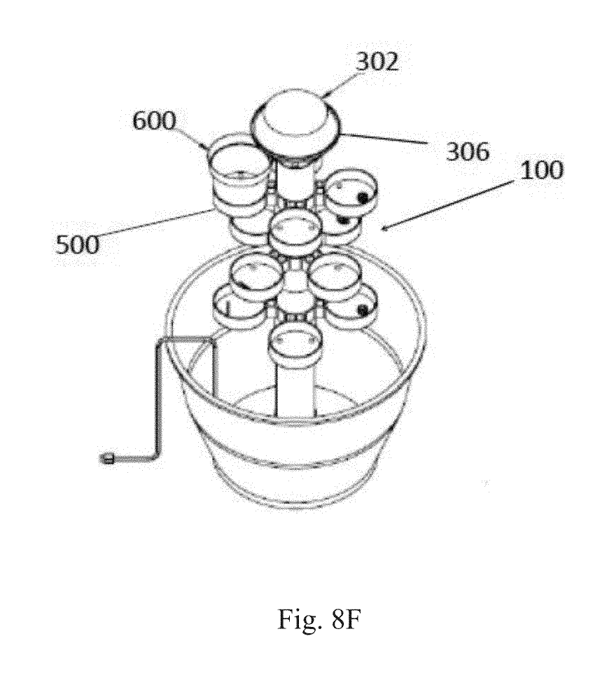

FIGS. 8A-8F illustrate steps to assemble a modular system embodiment 100. In the first step, FIG. 8A shows an embodiment where the support column pillar 400 or base support pillar 410 of the support pillar 400 is connected to the tank 200, for example extending from a pillar seat 202 (see FIG. 2). The irrigation hose 706 can be run through the base support pillar 410, for example via entry through a hole 402 as shown in FIG. 4A. In the second step, FIG. 8B shows an embodiment where a spacer 414 is connected to the base support pillar 410, for example using the spacer connector 416. In the third step, FIG. 8C shows a receptacle tray 500 is slid over the spacer 414. In the fourth step, FIG. 8D shows that a subsequent spacer 414 is connected to the first spacer 414, for example using another spacer connector 416. Additions of more spacers 414, spacer connectors 416, and receptacle trays 500 can be repeated until the desired height of the system 100 is reached. In FIG. 8E the liquid distribution device 300 is positioned at or near the top of the support column pillar 400. For example, the distributing pan 306 may be fitted on top of the last spacer 414. The irrigation hose connector of liquid distribution pan 306, as shown in FIG. 3A, can connect to the irrigation hose 706. The apex filter 304 is then placed in the liquid distributing pan 306. In the last step, FIG. 8F shows how receptacles 600 are placed upon the receptacle trays 500 and a lid 302 is placed on top of the liquid distributing pan 306 in order to complete the system 100.

### Terminology

Many other variations than those described herein will be apparent from this disclosure. For example, depending on the embodiment, certain acts, events, or functions of any of the steps described herein can be performed in a different sequence, can be added, merged, or left out altogether (e.g., not all described acts or events are necessary for the practice of the algorithms). Moreover, in certain embodiments, acts or events can be performed concurrently. In addition, different tasks or processes can be performed by different machines and/or computing systems that can function together.

The foregoing description and examples has been set forth merely to illustrate the disclosure and are not intended as being limiting. Each of the disclosed aspects and embodiments of the present disclosure may be considered individually or in combination with other aspects, embodiments, and variations of the disclosure. In addition, unless otherwise specified, none of the steps of the methods of the present disclosure are confined to any particular order of performance. Modifications of the disclosed embodiments incorporating the spirit and substance of the disclosure may occur to persons skilled in the art and such modifications are within the scope of the present disclosure. Furthermore, all references cited herein are incorporated by reference in their entirety.

Terms of orientation used herein, such as “top,” “bottom,” “horizontal,” “vertical,” “longitudinal,” “lateral,” and “end” are used in the context of the illustrated embodiment. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular” or “cylindrical” or “semi-circular” or “semi-cylindrical” or any related or similar terms, are not required to conform strictly to the mathematical definitions of circles or cylinders or other structures, but can encompass structures that are reasonably close approximations.

Conditional language used herein, such as, among others, “can,” “might,” “may,” “e.g.,” and the like, unless specifically stated otherwise, or otherwise understood within the context as used, is generally intended to convey that some embodiments include, while other embodiments do not include, certain features, elements, and/or states. Thus, such conditional language is not generally intended to imply that features, elements, blocks, and/or states are in any way required for one or more embodiments or that one or more embodiments necessarily include logic for deciding, with or without author input or prompting, whether these features, elements and/or states are included or are to be performed in any particular embodiment.

The term “about” as used herein represent an amount close to the stated amount that still performs a desired function or achieves a desired result. For example, in some embodiments, as the context may dictate, the terms “about” may refer to an amount that is within less than or equal to 10% of the stated amount.

Unless otherwise explicitly stated, articles such as “a” or “an” should generally be interpreted to include one or more described items. Accordingly, phrases such as “a device configured to” are intended to include one or more recited devices. Such one or more recited devices can be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

Although vertical aquaponic devices have been disclosed in the context of certain embodiments and examples, this disclosure extends beyond the specifically disclosed embodiments to other alternative embodiments and/or uses of the embodiments and certain modifications and equivalents thereof. Various features and aspects of the disclosed embodiments can be combined with or substituted for one another in order to form varying vertical aquaponic devices. The scope of this disclosure should not be limited by the particular disclosed embodiments described herein.

Certain features that are described in this disclosure in the context of separate implementations can be implemented in combination in a single implementation. Conversely, various features that are described in the context of a single implementation can be implemented in multiple implementations separately or in any suitable subcombination. Although features may be described herein as acting in certain combinations, one or more features from a claimed combination can, in some cases, be excised from the combination, and the combination may be claimed as any subcombination or variation of any subcombination.

While the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various embodiments described and the appended claims. Further, the disclosure herein of any particular feature, aspect, method, property, characteristic, quality, attribute, element, or the like in connection with an embodiment can be used in all other embodiments set forth herein. Any methods disclosed herein need not be performed in the order recited. Depending on the embodiment, one or more acts, events, or functions of any of the algorithms, methods, or processes described herein can be performed in a different sequence, can be added, merged, or left out altogether (e.g., not all described acts or events are necessary for the practice of the algorithm). In some embodiments, acts or events can be performed concurrently, e.g., through multi-threaded processing, interrupt processing, or multiple processors or processor cores or on other parallel architectures, rather than sequentially. Further, no element, feature, block, or step, or group of elements, features, blocks, or steps, are necessary or indispensable to each embodiment. Additionally, all possible combinations, subcombinations, and rearrangements of systems, methods, features, elements, modules, blocks, and so forth are within the scope of this disclosure. The use of sequential, or time-ordered language, such as “then,” “next,” “after,” “subsequently,” and the like, unless specifically stated otherwise, or otherwise understood within the context as used, is generally intended to facilitate the flow of the text and is not intended to limit the sequence of operations performed. Thus, some embodiments may be performed using the sequence of operations described herein, while other embodiments may be performed following a different sequence of operations.

Moreover, while operations may be depicted in the drawings or described in the specification in a particular order, such operations need not be performed in the particular order shown or in sequential order, and all operations need not be performed, to achieve the desirable results. Other operations that are not depicted or described can be incorporated in the example methods and processes. For example, one or more additional operations can be performed before, after, simultaneously, or between any of the described operations. Further, the operations may be rearranged or reordered in other implementations. Also, the separation of various system components in the implementations described herein should not be understood as requiring such separation in all implementations, and it should be understood that the described components and systems can generally be integrated together in a single product or packaged into multiple products. Additionally, other implementations are within the scope of this disclosure.

Some embodiments have been described in connection with the accompanying figures. Certain figures are drawn and/or shown to scale, but such scale should not be limiting, since dimensions and proportions other than what are shown are contemplated and are within the scope of the embodiments disclosed herein. Distances, angles, etc., are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

The methods disclosed herein may include certain actions taken by a practitioner; however, the methods can also include any third-party instruction of those actions, either expressly or by implication.

In summary, various embodiments and examples of vertical aquaponic devices have been disclosed. Although vertical aquaponic devices have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Thus, the scope of this disclosure should not be limited by the particular disclosed embodiments described herein, but should be determined only by a fair reading of the claims that follow.

The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 1 V” includes “1 V.” Phrases preceded by a term such as “substantially” include the recited phrase and should be interpreted based on the circumstances (e.g., as much as reasonably possible under the circumstances). For example, “substantially perpendicular” includes “perpendicular.” Unless stated otherwise, all measurements are at standard conditions including temperature and pressure.

What is claimed is:

1. A vertical aquaponic system comprising:
a tank;
a support column pillar;
a distribution device, wherein the distribution device comprises of an apex filter and a distributing pan,
wherein the distributing pan further comprises of at least one agitating port that is configured to aerate liquid via splashing,
wherein the distributing pan is configured to rotate around the support column pillar,
wherein the apex filter rests on the distributing pan, and
an irrigation hose of the pump, configured to travel through the support column pillar and connect to the distribution device and configured to allow liquid to travel upwards to the distribution device;
at least one receptacle,
at least one receptacle tray, wherein the receptacle tray comprises of at least one support frame arranged around a center anchoring ring which is configured to allow the receptacle tray to rotate around the modular support column pillar,
wherein the receptacle is configured to rest in the receptacle lobes and the receptacle is configured to be modular and can be detached or removed from the receptacle tray,
wherein the receptacle trays are between the distribution device and the tank, and
wherein the liquid is configured to flow through the distribution device and flows through the receptacles back down to the tank.

2. The system of claim 1, wherein the support column pillar is hollow and comprises of a base support pillar, at least two spacers, and at least one spacer connector.

3. The system of claim 1, wherein the receptacle further comprises cinder.

4. The system of claim 3, wherein the cinder is bacteria treated.

5. The system of claim 1, wherein a pump is used to move liquid, and the pump can be powered by solar power or electricity.

6. The system of claim 1, wherein the system further comprises of at least one grow light.

7. The system of claim 1, wherein at least three receptacle trays are attached to the support column pillar via center anchoring rings and arranged vertically and between the distribution device and tank.

8. The system of claim 1, wherein the receptacle tray comprises of at least one receptacle ring unit.

9. An aquaponic system comprising:
a tank configured to retain fluid;
a hollow support column pillar extending from the tank;
a first tray configured to rotate about the support pillar, the first tray comprising a first support frame configured to receive a plant, the first support frame comprising at least one irrigation hole; and
a distribution device configured to distribute fluid through the first support frame and toward the tank, the hollow support column pillar extending from the tank to the distribution device.

10. The aquaponic system of claim 9, further comprising a pump configured to direct fluid from the tank and toward the distribution device.

11. The aquaponic system of claim 10, wherein the pump is configured to direct fluid through the hollow support column pillar and toward the distribution device.

12. The aquaponic system of claim 10, wherein the pump is positioned in the tank.

13. The aquaponic system of claim 9, wherein the tray comprises a central anchor configured to rotate about the support pillar, the first support frame being positioned radially outward from the central anchor.

14. The aquaponic system of claim 13, wherein a central longitudinal axis of the first support frame is parallel to a central longitudinal axis of the central anchor.

15. The aquaponic system of claim 9, wherein the support column pillar is modular.

16. The aquaponic system of claim 9, wherein the support column pillar is configured to removably connect to the tank and the distribution device.

17. The aquaponic system of claim 9, wherein the distribution device further comprises a filter and a distributing pan configured to receive the filter.

18. The aquaponic system of claim 17, wherein the distributing pan comprises a discharge port configured to direct fluid into the first receptacle unit.

19. The aquaponic system of claim 9, further comprising a second tray configured to rotate about the support pillar, the second tray comprising a second support frame configured to receive another plant.

20. The aquaponic system of claim 19, wherein the second tray is positioned between the first tray and the tank such that fluid flowing through the at least one irrigation hole of the first support frame flows into the second support frame of the second tray.

21. An aquaponic system comprising:
a tank configured to retain fluid;
a hollow support column pillar extending from the tank;
a first tray configured to rotate about the support pillar, the first tray comprising a plurality of receptacle units, each support frame of the first tray being configured to receive a plant;
a second tray configured to rotate about the support pillar, the second tray comprising a plurality receptacle units, each support frame of the second tray being configured to receive another plant,
wherein the second tray is positioned between the first tray and the tank such that fluid flowing through one of the receptacle units of the first tray flows into one of the receptacle units of the second tray.

22. The aquaponic system of claim 21, further comprising a distribution device configured to distribute fluid through the plurality of receptacle units of the first tray and toward the tank.

23. The aquaponic system of claim 22, wherein the distribution device comprises a filter and a distributing pan configured to receive the filter.

24. The aquaponic system of claim 23, wherein the distributing pan comprises a plurality of discharge ports configured to direct fluid into the plurality of receptacle units of the first tray.

25. The aquaponic system of claim 21, further comprising a pump configured to direct fluid from the tank and toward the distribution device.

26. The aquaponic system of claim 25, wherein the pump is configured to direct fluid through the hollow support column pillar and toward the distribution device.

27. The aquaponic system of claim 26, wherein the pump is positioned in the tank.

28. The aquaponic system of claim 21, wherein the first tray comprises a central anchor configured to rotate about the support pillar, the plurality of receptacle units of the first tray being positioned radially outward from the central anchor.

29. The aquaponic system of claim 28 wherein a central longitudinal axis of each of the receptacle units of the first tray is parallel to a central longitudinal axis of the central anchor.

30. The aquaponic system of claim 21, wherein the support column pillar is configured to removably connect to the tank.

31. The aquaponic system of claim 21, wherein the support column pillar is modular.

32. An aquaponic system comprising:
a tank configured to retain fluid;
a hollow support column pillar extending from the tank;
a distribution device comprising a first filter and a distributing pan configured to receive the first filter, the hollow support column pillar extending from the tank to the distribution device;
a tray positioned between the distribution device and the tank, the tray comprising a support frame and a second filter positioned in the receptacle unit, the second filter being a different type of filter than the first filter.

33. The aquaponic system of claim 32, wherein the tray is configured to rotate about the support pillar.

34. The aquaponic system of claim 32, wherein the first filter is a physical filter and the second filter is a bacteria treated filter.

35. The aquaponic system of claim 32, wherein the first filter comprises a sponge and the second filter comprises bacteria treated cinder.

36. The aquaponic system of claim 32, further comprising a pump configured to direct fluid from the tank and toward the distribution device.

37. The aquaponic system of claim 36, wherein the pump is configured to direct fluid through the hollow support column pillar and toward the distribution device.

38. The aquaponic system of claim 36, wherein the pump is positioned in the tank.

39. The aquaponic system of claim 32, wherein the support column pillar is configured to removably connect to the tank and the distribution device.

40. The aquaponic system of claim 32, wherein the support column pillar is modular.

41. The aquaponic system of claim 32, further comprising a second tray configured to rotate about the support pillar, the second tray comprising a second support frame configured to receive a plant.

42. The aquaponic system of claim 41, wherein the second tray is positioned between the first tray and the tank such that fluid flowing through the support frame of the tray flows into the second support frame of the second tray.
